(19) United States
(12) Patent Application Publication
(10) Pub. No.: US 2026/0052131 A1
(43) Pub. Date: Feb. 19, 2026

(54) DATA PROCESSING METHOD AND ELECTRONIC DEVICE

(71) Applicant: Lenovo (Beijing) Limited, Beijing (CN)

(72) Inventors: Ke WANG, Beijing (CN); Wenlong DU, Beijing (CN)

(21) Appl. No.: 19/224,701

(22) Filed: May 30, 2025

(30) Foreign Application Priority Data
Jun. 28, 2024 (CN) 202410869398.6

(51) Int. Cl. H04L 9/40

(52) U.S. Cl. CPC H04L 63/0428

(57) ABSTRACT

A data processing method includes: after establishing a first connection with a first device, obtaining device information of each processing device in a device group where the first device is located; establishing a second connection with a target processing device in the device group based on the device information, and sending a target processing task to the target processing device through the second connection; outputting a target processing result for the target processing task fed back by the target processing device through the second connection, where the first connection is different from the second connection, and the client device and the processing device are in a same network or different networks.

### CROSS-REFERENCE TO RELATED APPLICATION

This application claims priority to Chinese Patent Application No. 202410869398.6, filed on Jun. 28, 2024, the content of which is incorporated herein by reference in its entirety.

### TECHNICAL FIELD

The application generally relates to the field of computer technology, and in particular to a data processing method and an electronic device thereof.

### BACKGROUND

Currently, there are more and more types of artificial intelligence (AI) devices, such as AI personal computers (PCs), AI mobile phones, AI tablets, etc. At the same time, AI devices support AI reasoning capabilities, such as artificial intelligence generated content (AIGC) reasoning capabilities, which are gradually enriched, improving the efficiency and intelligence of users'work and life.

Local AI reasoning means implementing AI reasoning on a local device without uploading user data to the cloud. Therefore, local AI reasoning has higher privacy and security, and may provide users with a better AI experience.

However, due to differences in machine performance among various AI devices, the reasoning capabilities and speeds of AI inference models provided by various AI device suppliers are also different. In addition, non-AI PCs or AI positioning devices have computing power and power consumption limitations, making it difficult for users to implement local AI reasoning functions.

### SUMMARY

One aspect of the present disclosure provides a data processing method, which is applied to a client device, and the method includes: after establishing a first connection with a first device, obtaining device information of each processing device in a device group where the first device is located; establishing a second connection with a target processing device in the device group based on the device information, and sending a target processing task to the target processing device through the second connection; and outputting a target processing result for the target processing task fed back by the target processing device through the second connection, where the first connection is different from the second connection, and the client device and the processing device are in a same network or in different networks.

Another aspect of the present disclosure provides another data processing method, which is applied to a first processing device, and the method includes: after establishing a second connection with a client device, receiving a target processing task sent by the client device; processing the target processing task with a corresponding processing strategy based on task information of the target processing task; and encrypting a target processing result of the target processing task and sending the encrypted target processing result to the client device through the second connection, where the second connection is established by the client device based on first device information of the first processing device, and the first device information is obtained by the client device, from device information of each processing device in a device group where the first device is located, through a first connection between the client device and the first device, and where the first connection is different from the second connection, and the client device and the first processing device are in a same network or in different networks.

Another aspect of the present disclosure provides an electronic device. The electronic device includes one or more processors and a memory containing a computer program that, when being executed, causes the one or more processors to perform: after establishing a first connection with a first device, obtaining device information of each processing device in a device group where the first device is located; establishing a second connection with a target processing device in the device group based on the device information, and sending a target processing task to the target processing device through the second connection; and outputting a target processing result for the target processing task fed back by the target processing device through the second connection, where the first connection is different from the second connection, and the client device and the processing device are in a same network or in different networks.

It should be understood that the above general description and the following detailed description are merely exemplary and explanatory, and are not intended to limit the technical solutions of the present disclosure.

### BRIEF DESCRIPTION OF THE DRAWINGS

In order to more clearly illustrate the technical solutions in the embodiments of the disclosure, the drawings essential for understanding the disclosed embodiments will be briefly described below. Apparently, the drawings described below are merely some embodiments of the disclosure. For a person skilled in the art, other drawings may be obtained based on the provided drawings without making creative efforts.

FIG. 1 is a flowchart of a data processing method, according to some embodiments of the present disclosure;

FIG. 2 is a flowchart of another data processing method, according to some embodiments of the present disclosure;

FIG. 3 is a schematic diagram of a network architecture on which a disclosed data processing method is implemented, according to some embodiments of the present disclosure;

FIG. 4 is a schematic diagram of a system architecture of a data processing device disposed in a client device, according to some embodiments of the present disclosure;

FIG. 5 is a schematic diagram of a system architecture of a data processing device disposed in a target processing device, according to some embodiments of the present disclosure; and

FIG. 6 is a schematic diagram of the hardware entities of a computer device, according to some embodiments of the present disclosure.

### DETAILED DESCRIPTION

In order to make the purposes, technical solutions and advantages of the present disclosure clearer, the technical solutions of the present disclosure are further elaborated in detail hereafter in conjunction with the accompanying drawings and specific embodiments. The described embodiments should not be regarded as limiting the present disclosure. All other embodiments obtained by a person skilled in the art without making creative efforts are within the scope of protection of the present disclosure.

In the following descriptions, reference is made to “some embodiments”, which describe a subset of all possible embodiments, but it will be understood that “some embodiments” may be the same subset or different subsets of all possible embodiments and may be combined with each other without conflict.

The terms “first/second/third” involved are merely used to distinguish similar objects and do not represent a specific ordering of the objects. It is understandable that “first/second/third” may be interchanged with a specific order or sequence where permitted so that the embodiments of the present disclosure described herein may be implemented in an order other than that illustrated or described herein.

Unless otherwise defined, the technical and scientific terms used herein have similar meanings as those commonly understood by those skilled in the art. The terms used herein are merely for the purpose of describing the present disclosure and are not intended to limit the present disclosure.

In order to use local AI reasoning capabilities, users need to purchase various common devices with AI reasoning capabilities, such as AI PCs, AI phones, AI tablets, etc., which results in high user expense. In addition, the local AI reasoning models pre-installed by various AI device vendors are not completely consistent, so the reasoning capabilities, reasoning efficiency, and reasoning results are also different, resulting in poor user experience.

In view of the foregoing, the embodiments of the present disclosure provide a data processing method, which is applied to a client device, and the method may be executed by a processor of the client device. The client device may refer to a server, a laptop, a tablet, a desktop computer, a smart TV, a set-top box, a mobile device (such as a mobile phone, a portable video player, a personal digital assistant, a dedicated messaging device, a portable gaming device), and other devices with data processing capabilities.

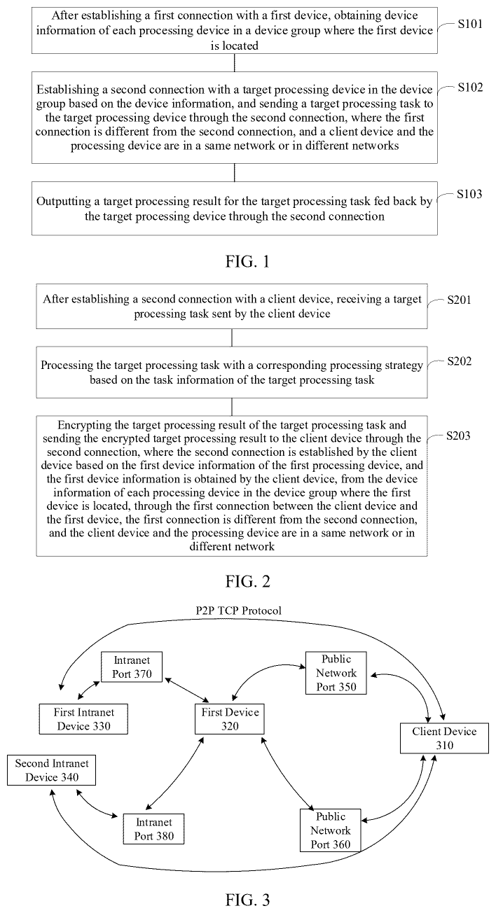

FIG. 1 is a flowchart of a data processing method provided by the present disclosure. As shown in FIG. 1, the method includes the following Steps S101 to S103.

Step S101: After establishing a first connection with a first device, obtain device information of each processing device in a device group where the first device is located, where a client device and the processing device are in a same network or in different networks.

In some embodiments, the client device refers to a device that does not have the processing capability required for a target processing task. In some embodiments, the client device refers to a client device that does not have the AI reasoning capability required for the target processing task. Therefore, after the client device establishes an AI reasoning task, it is necessary to call other devices with AI reasoning capabilities to perform the AI reasoning task.

The first device is a device used to process the target processing task sent by the client device according to a preset task processing strategy.

In some embodiments, the first device may include an electronic device with AI reasoning capabilities, such as an AI PC, an AI tablet, an AI server, and the like.

In some embodiments, the first device may include an electronic device that does not have AI reasoning capabilities. For example, the first device is a host device or a server device configured to establish a device group including at least one electronic device with AI reasoning capabilities, or to relay data transmitted from a client device to an electronic device with AI reasoning capabilities.

The first connection refers to a network connection established between the client device and the first device.

In some embodiments, the first connection may include a wired connection, such as a telephone line connection, an optical fiber connection, or the like.

In some embodiments, the first connection may include a wireless connection, such as a Wi-Fi connection, a Bluetooth connection, a mobile data connection, or the like.

In this way, a first connection is established. That is, the client device is connected to the first device via a wired or wireless connection.

A device group refers to a device pool that includes at least one processing device with data processing capabilities.

In some embodiments, the device group includes at least one processing device having AI reasoning capability (e.g., AIGC reasoning capability).

In some embodiments, the device group may also include processing devices that do not have AI reasoning capabilities, such as PCs or servers that do not have AI reasoning capabilities. In this way, when a target processing task acquired by the client device is an AI reasoning task, it is necessary to screen multiple processing devices in the device group according to whether they have AI reasoning capabilities, to determine at least one processing device with AI reasoning capabilities.

In some embodiments, when the first device is a host device, the device group may be a group of processing devices established by the first device.

In some embodiments, at least one second device establishes a Socket connection with the first device for synchronous communication and maintains a long connection, thereby establishing a device group with the first device as a host device.

In some embodiments, the first device establishes a device group based on the attribute information of each processing device. For example, the first device determines at least one third device with a same type of user identification information as a device group. For another example, the first device determines at least one fourth device with a same type of AI reasoning capacities as a device group. For another example, the first device determines at least one fifth device with a same type of device identification as a device group, and so on.

In this way, the first device places processing devices with a same type of attribute information in a same device group, which facilitates a search for an adapted device group based on the attribute information.

A processing device refers to an electronic device that may provide AI reasoning capabilities or AI services. In some embodiments, the processing device is installed with an AI reasoning application to implement AI reasoning capabilities.

Device information refers to identification information, network information, hardware resource information, software resource information, and so on related to the processing device. In some embodiments, the device information may include the device identification, device network address, device configuration information, and device load status information of the processing device, etc. The hardware resource information may include the configuration of the central processing unit (CPU), graphics processing unit (GPU), memory, etc.

In some embodiments, the client device and the processing device may be in a same network. For example, when the client device is a user's mobile phone device and the processing device is the user's AI tablet or AI PC with AI reasoning capabilities, the client device and the AI tablet or AI PC may all be in the user's home network.

In some embodiments, the client device and the processing device may be in different networks. For example, when the client device is a user's mobile device and the processing device is an AI server or AI PC with AI reasoning capabilities in the user's office, the client device may be located in the user's home network, while the AI server or AI PC may be in the office network.

In some embodiments, the first device has a large memory space to maintain a long connection with each processing device in the device group and store device information of each processing device in the device group.

In some embodiments, each processing device in the device group periodically sends its device information to the first device.

In some embodiments, the first device may actively obtain device information of each processing device after receiving a target processing task sent by the client device or after establishing a first connection with the client device.

Step S102: Establish a second connection with a target processing device in the device group based on the device information, and send a target processing task to the target processing device through the second connection, where the first connection is different from the second connection.

Here, the target processing device refers to a device determined from the device group and used to process the target processing task sent by the client device.

In some embodiments, the target processing device may be determined by the client device. For example, based on the obtained device information of each processing device, the client device determines a processing device with the highest computing power, in an idle state and in the best network condition among at least one processing device as the target processing device.

In some embodiments, the target processing device may be specified from a device group by a current user of the client device.

After determining the target processing device, the client device may establish a second connection with the target processing device based on the device information of the target processing device.

In some embodiments, the client device establishes a second connection with the target processing device based on the device identification or network address of the target device.

In some embodiments, the second connection may be a point-to-point connection established between the client device and the target processing device.

Here, the point-to-point connection refers to a connection established between a single originating device and a single destination device. In some embodiments, the point-to-point connection between the client device and the target processing device refers to a peer-to-peer (P2P) connection established between the client device and the target processing device.

In some embodiments, a P2P management server may be used to establish a network connection between each processing device in the device group and client device, and collect the network status information of each processing device and client device (e.g., whether the device supports intranet penetration). In this way, after the client device determines the target processing device, it may query the P2P management server for the network status information of the target processing device, and establish a P2P connection with the target processing device if the target processing device supports intranet penetration.

In some embodiments, the second connection may be an indirect connection between the client device and the target processing device via a relay server. For example, when the client device and/or the target processing device do not support P2P connection, a relay server may be used to forward the target processing task sent by the client device to the target processing device.

In some embodiments, the first connection is different from the second connection, which may include that the communication protocols of the first connection and the second connection are different. For example, the first connection may be a network connection established by a public internet protocol (IP) protocol, a secure reliable transport (SRT) protocol, etc. The second connection may be a connection established by a P2P-based TCP protocol.

In some embodiments, the first connection is different from the second connection, which may include that the connection purposes of the first connection and the second connection are different. For example, the first connection is used to establish a network connection between the client device and the device group to transmit device information. The second connection is used to transmit data between the client device and the target processing device. That is, to achieve secure transmission of the target processing task and a target processing result.

In some embodiments, before the client device sends the target processing task to the target processing device through the second connection, the client device also performs encryption processing on the target processing task to improve the security of data transmission.

The target processing task may be an AI reasoning task established on the client device, such as an AIGC reasoning task. In some embodiments, the target processing task may be a task that requires the use of an AI application to perform a task such as generating images using text, generating videos using text, text expansion, PPT production, a summary task, image recognition, beautification, etc.

In this way, the client device may send the encrypted target processing task to the target processing device through the P2P connection or the relay server.

Step S103: Output a target processing result for the target processing task fed back by the target processing device through the second connection, where the first connection is different from the second connection, and the client device and the processing device are in the same network or different networks.

Here, after the target processing task is executed, the client device receives the target processing result corresponding to the target processing task from the target processing device through the second connection.

In some embodiments, outputting the target processing result may include outputting the target processing result by displaying it on the client device, outputting the target processing result by audio, or outputting the target processing result in any other manner supported by the client device.

In some embodiments, the target processing result is encrypted information. Therefore, before outputting the target processing result, the target processing result is also decrypted to obtain and output the decrypted target processing result.

In the data processing method applied to a client device provided by the present disclosure, after the client device establishes a first connection with a first device, the client device obtains device information of each processing device in a device group where the first device is located, and establishes a second connection with a target processing device in the device group based on the device information. The client device then sends a target processing task to the target processing device through the second connection, and outputs a target processing result for the target processing task fed back by the target processing device through the second connection. Here, the first connection is different from the second connection, and the client device and the processing device are in the same network or different networks. In this way, the client device may send the target processing task through the first device to the target processing device in the device group for processing, so that the processing device in the device group may be used to perform the task. At the same time, the first device manages at least one processing device in the device group to assist in establishing a second connection between the client device and the target processing device, and selects the best target processing device, so as to optimize the resource utilization of the client device for at least one processing device. In addition, the first connection between the client device and the first device is different from the second connection between the client device and the target processing device. That is, different connection methods are used to realize the transmission of device information and the transmission of target processing tasks and target processing results. This improves the diversity of network connections, and then improves the security of data transmission, especially when the second connection is a P2P connection, which may also improve the transmission efficiency and security of target processing tasks and target processing results.

In some embodiments, obtaining the device information of each processing device in the device group where the first device is located (i.e., Step S101) may be implemented as one of the following Steps S1011 to S1014.

Step S1011: After the client device establishes a first connection with the first device through the first application, display the device information of each processing device in the device group in a window interface of a first application.

Here, the first application is an application program used to establish device interconnection between the client device and the first device.

In some embodiments, the first application may provide a window interface for interaction with a user. In some embodiments, the window interface of the first application may include a string information input area, a voice input control, a file upload control, a picture upload control, an information display output area, and so on, to support the user to input various types of instructions, and view the device information of a processing device, the task processing progress, the task processing result, and so on in a display area.

In some embodiments, by installing the first application on the client device and the first device respectively and logging in to the first application, the first device may be used to manage the target processing task initiated by the client device.

In some embodiments, the first application may be installed on the client device, the first device and at least one processing device. The accounts with associated relationships or the same account may be logged into these devices respectively, thereby establishing a network interconnection between the client device, the first device and at least one processing device, so that the target processing task of the client device may be forwarded to at least one processing device for processing.

In some embodiments, the client device establishes the first connection with the first device through the first application, which may be that the client device accesses the first device through the first application and establishes socket synchronous communication to maintain a long connection.

When the first device is a public network device, for example, a public network host device provided by a service provider, a user may log in to an account registered in a server of the service provider on a first application installed on the client device to access the first device.

When the first device is a host device in a local area network, for example, a master control device in a home network or an office network, a user may log into a self-designed login account on a first application installed on the client device to access the first device.

In some embodiments, after establishing the first connection, the first device may send the device information of each processing device in the device group it manages to the client device through the first connection. In this way, the device information of each processing device in the device group may be displayed and output in the window interface of the first application for the user to view.

Step S1012: In response to the client device running the first application, establish a first connection with the first device, display each processing device in the device group managed by the first device in the window interface of the first application, and display the device information of the corresponding processing device in response to a trigger operation acting on the window interface.

Here, the description of the first application may be found in Step S1011, which will not be repeated here.

After the client device runs the first application, a first connection between the client device and the first device is established through the first application, and each processing device in the device group managed by the first device is received from the first device through the first connection.

In some embodiments, the identification information corresponding to each processing device is displayed in the window interface of the first application installed on the client device. In some embodiments, the identification information corresponding to a processing device may include the device name, network location, icon and/or device physical address of the processing device, etc.

In this way, in response to a trigger operation performed by a user on the window interface of the first application, a processing device corresponding to the trigger operation is determined, and more detailed device information corresponding to the processing device is displayed in the window interface.

In this way, when there are a large number of processing devices in the device group managed by the first device, the processing devices may be displayed by displaying only the identification information corresponding to the processing devices, which may save the display space of the window interface of the first application and facilitate users to quickly browse which processing devices are included in the device group.

Step S1013: In response to obtaining a target processing task, establish a first connection with the first device to obtain device information of each processing device through the first connection, or display the device information of a processing device on the current display interface of the client device.

Here, the target processing task may be a text-to-image generation task, a text-to-video generation task, a text expansion task and/or an image recognition task, or the like, which is input by the user through voice, string input, gesture input, etc.

After the client device obtains the target processing task, the client device establishes a first connection with the first device. That is, the client device obtaining the target processing task is a condition that triggers the establishment of the first connection.

The client device obtains device information of each processing device in the device group from the first device through the first connection to determine a target processing device based on the device information. Alternatively, the client device displays the obtained device information on the current display interface so that a user may browse and select a target processing device from at least one processing device.

In some embodiments, after the client device obtains the target processing task, the client device may call the first application to establish a first connection with the first device through the first application.

Step S1014: In response to obtaining target interactive content in a second application, trigger the client device to run the first application to establish a first connection with the first device, so as to obtain the device information of each processing device through the first connection, or display the device information of each processing device in a window interface of the second application.

In some embodiments, the second application may be a social application running on the client device. For example, the second application may be an instant messaging application, such as WeChat®, QQ®, work collaboration software (e.g., Teams®), Weibo®, and the like.

In this way, when a user uses the second application to interact with others, if tasks such as text generation and text expansion occur, a client device may be triggered to call the first application to establish a corresponding target processing task, and then establish a first connection with the first device.

In some embodiments, the client device receives device information of at least one processing device from the first device through the first connection, and automatically determines a target processing device from the at least one processing device based on the device information.

In some embodiments, the client device receives device information of at least one processing device from the first device through the first connection, and displays the device information in a window interface of the second application so that the user may select a target processing device from the at least one processing device based on the displayed device information.

In the above embodiments, the client device may establish a first connection with the first device in response to the first application running, and obtain the target processing task or the target interactive content in the second application, thereby obtaining the device information of at least one processing device in the device group managed by the first application. In this way, the user may conveniently call the processing device in the device group to perform task processing in a variety of scenarios, thereby improving the convenience of user operation and the intelligence of the client device.

In some embodiments, establishing the second connection with the target processing device in the device group based on the device information in the above Step S102 may be implemented as at least one of the following Steps S1021 to S1024.

Step S1021: Determine a target processing device from the device group, and establish a second connection based on device network information of the target processing device.

In some embodiments, determining a target processing device from the device group may be that the client device determines the target processing device from the device group based on the device information. For example, the client device may determine the target processing device from the device group based on computing power information, current task information, idle state information, and so on in the device information. For example, the client device may determine the processing device with the highest computing power, the least current task, and/or in an idle state as the target processing device.

In some embodiments, the target processing device is determined from the device group by a user selecting a target processing device from the device group based on the device information displayed and output by the client device. For example, the user may select a target processing device from the device group based on the device identification of the commonly used processing device.

In some embodiments, the target processing device determined from the device group may be unique. In the case where the target processing device is unique, the client device sends the target processing task to the unique target processing device, so that the target processing device further determines whether to perform the target processing task by itself or select other processing devices in the device group to jointly perform the target processing task.

In some embodiments, there may be multiple target processing devices determined from the device group. In the case of multiple target processing devices, the client device may split the target processing task into multiple subtasks, send the multiple subtasks to the corresponding target processing devices respectively, and use the multiple target processing devices to execute the corresponding subtasks respectively.

The above device network information may include network address information, network port information, and/or network identity document (ID), and the like corresponding to a processing device.

In this way, the client device may establish a second connection with the target processing device based on the device network information of the target processing device. For example, if both the client device and the target processing device support P2P connection, the client device may establish a P2P connection with the target processing device based on the network port information of the target processing device.

Step S1022: In response to accepting the target processing device recommended by the first device, establish the second connection based on the device network information of the target processing device.

Here, after the client device establishes a first connection with the first device, the first device determines a target processing device from at least one processing device based on device information of at least one processing device in the device group, and sends the device information of the target processing device to the client device.

In some embodiments, in response to establishing the first connection, the first device obtains corresponding device information from each processing device in the device group, and determines a target processing device from the device group based on the device information of each processing device.

In some embodiments, the first device determines the target processing device from the device group based on the hardware configuration, computing power, current pending tasks, idle state information, network status, software configuration and other device information of each processing device.

In some embodiments, the first device determines the target processing device from the device group based on the operation record of the user in the specified time period. For example, the target processing device is determined from the device group according to the frequency of the user selecting each processing device as the target processing device in the specified time period.

In some embodiments, the first device sorts the processing devices according to the device information of the processing devices and the user's operating habits in a specified time period, and sends the device information of a specified number of processing devices to the client device according to the sorting result.

In this way, after the client device accepts the target processing device recommended by the first device, the client device establishes a second connection with the target processing device based on the device network information of the target processing device, to send a target processing task to the target processing device through the second connection.

Step S1023: Determine a target processing device from the device group, and establish the second connection based on the device identification information of the target processing device.

In some embodiments, determining a target processing device from a device group may include that the client device or a current user of the client device determines the target processing device from at least one processing device based on device information of at least one processing device.

Here, the device identification information may include a device ID, a device name, and the like corresponding to the device.

In some embodiments, the client device determines the device network information of the target processing device (e.g., determines the network address information, network port information, network ID, and the like for the target processing device) based on the device identification information of the target processing device and the stored correspondence between the device identification and device network information of the processing device, and then establishes a second connection with the target processing device based on the network information of the target processing device.

Step S1024: In response to accepting the target processing device recommended by the first device, establish the second connection based on the device identification information of the target processing device.

In some embodiments, in response to establishing a first connection with the client device, the first device determines a target processing device from at least one processing device based on device information of at least one processing device in the device group, and sends the target processing device to the client device.

In some embodiments, the client device determines the device network information of the target processing device (e.g., determines the network address information, network port information, network ID, and the like for the target processing device) based on the device identification information of the target processing device and the stored correspondence between the device identification and device network information of the processing device, and then establishes a second connection with the target processing device based on the device network information of the target processing device.

In some embodiments, the second connection is a point-to-point connection between the client device and the target processing device.

In some embodiments, determining the target processing device from the device group in the above Step S1021 may be implemented as at least one of the following Steps S1025 to S1029.

Step S1025: Sort the processing devices based on the device configuration information and the device current operation information of the processing devices provided by the first device, and determine a first processing device in a top category as the target processing device.

Here, the device information includes device configuration information and current operation information of a corresponding processing device.

In some embodiments, the device configuration information may include hardware configuration information, software configuration information, computing power information, and the like of the corresponding processing device.

In some embodiments, the current operation information of the device may include the idle state information of the corresponding processing device within a past specified time period. Here, the idle state information of the processing device may be determined based on the current pending tasks of the processing device, the computing power of the processing device, etc. In some embodiments, the idle state information of the processing device may include idle, busy, full load, or abnormal.

Here, the processing devices are sorted based on their device configuration information and current device operation information. A first processing device in the top category. That is, a processing device in the idle state or the busy state and with the highest configuration, is determined as the target processing device.

In this way, the target processing device is determined from the device group based on the device configuration information and the current operating status information of the device, so as to provide the most efficient task processing performance for the client device.

Step S1026: Obtain task information of the target processing task, and determine a second processing device in the device group that may provide a functional service matching the task information as the target processing device.

Here, the task information may include information such as the task type, task requirements, and estimated duration corresponding to the target processing task.

Task types may include text-to-image, text-to-video, text expansion, image recognition, summary generation, etc.

Task requirements may include information such as the style or effect that a user inputs for the target processing task. For example, for a text-to-image task, the user may put forward requirements such as the style and size of the generated image.

Estimated duration refers to the estimated processing time based on task type or task requirements.

The functional services corresponding to a processing device are the data processing capabilities that the processing device may provide using its configured hardware or installed software. For example, a processing device with a text-to-image application installed may provide a text-to-image service. For another example, a processing device with an image recognition application installed may provide an image recognition service.

In this way, the task type corresponding to the target processing task has a correspondence with the functional service type of the processing device. According to the task type of the target processing task, the processing devices of the device group may be screened to determine a second processing device with a corresponding functional service type, for example, a second processing device that may provide a text-to-image service.

The task requirements of the target processing task have a correspondence with the functional service capabilities of the processing device. According to the task requirements, the processing devices in the device group may be screened to determine a second processing device with a corresponding functional service capability, for example, a second processing device that may offer a text-to-image service with a higher definition image.

According to the estimated duration of the task, a second processing device that may complete the target processing task within the duration threshold is screened out from the processing devices in the device group. For example, in the case where the estimated duration is long, a processing device with higher computing power is preferentially determined as the second processing device to complete the processing of the target processing task within the task processing duration threshold.

According to the estimated duration of the task, a second processing device in an idle state may be selected from the processing devices in the device group so as to start processing the target processing task more quickly.

Step S1027: Determine a target processing device from the device group based on the network configuration information and/or current network status information of each processing device.

Here, the network configuration information of the processing device refers to the network bandwidth, network protocol, network device, network security policy, etc., of the network supported by the processing device.

The current network status information refers to information such as the quality and stability of the network signal of the network supported by the processing device.

In some embodiments, based on the network configuration and/or the current network device, a processing device with the highest network bandwidth and better stability may be determined from the device group as the target processing device, so as to establish a stable and high-quality network connection between the client device and the target processing device, for example, a P2P connection, thereby improving the transmission stability and transmission efficiency of the target processing task.

In some embodiments, the target processing device may also be determined from the device group based on device configuration information, current device operation information, functional services that may be provided, network configuration information and/or current network status information of each processing device.

Step S1028: Obtain user profile information of a target user, and determine a target processing device from the device group based on the user profile information.

Here, user profile information may refer to historical information related to the user's operating habits or preferences.

In some embodiments, the user profile information represents the user's usage habits of the processing devices in the device group within a specified time period. For example, when the device group is a plurality of AI devices in the user's home network, the user profile information may represent the user's usage frequency information of each AI device within the specified time period.

In some embodiments, the user profile information represents the user's selection habits of processing devices in the device group when processing tasks of the same type as the target processing task within a specified time period. For example, in the AI reasoning task of generating images from user text, within a specified time period, the user is more inclined to choose to use an AI PC.

In this way, by determining the target processing device from the device group based on the user profile information, the determined target processing device may be made more in line with the user's operating habits or preferences, thereby making the target processing results more in line with the user's expectations and improving the user's usage experience.

Step S1029: Obtain a selection operation of the target user, and determine a third processing device in the device group that matches the selection operation as the target processing device.

Here, when the window interface of the client device displays the device information or device identification of each processing device in the device group, a user is allowed to actively select a target processing device from the displayed device information or device identification.

In some embodiments, the selection operation may include mouse operation, keyboard operation, voice operation, gesture operation, and any operation method that may be recognized by the client device.

In this way, based on the selection operation of the user, a third processing device corresponding to the selection operation may be determined, and the third processing device may be determined as the target processing device.

In the above embodiments, the target processing device is determined through the user's selection operation, so that the determined target processing device may better meet the user's current usage requirements.

In some embodiments, after determining the target processing device based on any one of the above Steps S1021 and S1023, the data processing method provided by the present disclosure further includes the following Step S10210.

Step S10210: After determining the target processing device, feed back the device identification information of the target processing device to the first device, so that the first device updates the device information of the processing devices in the device group.

Here, determining the target processing device means that the client device automatically determines the target processing device according to the device information of each processing device in the device group, or the user determines the target processing device from each processing device in the device group according to the device information displayed and output by the client device.

In some embodiments, after the client device feeds back the device identification information of the target processing device to the first device, the first device sends the device information of each processing device in the device group to the target processing device, so that the target processing device determines the processing strategy for the target processing task based on the device information of each processing device.

In some embodiments, after the client device feeds back the device identification information of the target processing device to the first device, the first device re-acquires the device information of each processing device in the device group and feeds back the re-acquired device information to the target processing device so that the target processing device may obtain the latest device information.

In some embodiments, the data processing method provided by the present disclosure may further include the following Step S104.

Step S104: When the second connection with the target processing device cannot be established, the target processing task is sent to the target processing device by using the first device.

Here, the second connection represents a point-to-point connection between the client device and the target processing device, for example, a P2P connection.

In this way, when the client device and the target processing device cannot establish a point-to-point connection, the client device sends the target processing task to the first device, and enables the first device to send the target processing task to the target processing device. That is, the first device is used to realize the transmission relay of the target processing task, thereby improving the diversity and flexibility of data transmission methods.

In some embodiments, sending the target processing task to the target processing device through the second connection in the above Step S102 may be implemented as the following Step S10211.

Step S10211: Exchange key data with the target processing device, use the key data to encrypt the target processing task and then send the encrypted task processing task to the target processing device through the second connection, where the target processing task includes at least one processing task, and different processing tasks correspond to different key data.

Here, when the client device sends the target processing data to the target processing device using the second connection (e.g., P2P connection), an encryption operation is performed on the target processing data.

In some embodiments, the key data includes an encryption suite and a key.

In some embodiments, the encryption suite may include an authentication algorithm, an encryption algorithm, a message authentication algorithm, a key exchange algorithm, and a key derivation algorithm, etc.

In some embodiments, the secret key may be generated based on device information of the client device, device information of the target processing device, task information of the target processing task, or other information.

In the case where the target processing task includes two or more processing tasks, corresponding key data may be assigned to each processing task, and the key data corresponding to different processing tasks are different, so as to achieve separate encrypted transmission of each processing task.

In the above embodiments, before sending the target processing task to the target processing device, the client device performs encryption processing on the target processing task, which may improve the transmission security of the target processing task.

In some embodiments, outputting a target processing result for the target processing task fed back by the target processing device through the second connection (i.e., Step S103) may be implemented as at least one of the following Steps S1031 to S1033.

Step S1031: Decrypt a target processing result fed back by the target processing device using the key data exchanged with the target processing device, and display the decrypted target processing result on a window interface of the first application or a current display interface of the client device.

In some embodiments, before the client device receives the target processing result from the target processing device, the client device may exchange key data with the target processing device so that the target processing device may encrypt the target processing result based on the exchanged key data and feed back the encrypted target processing result to the client device through the second connection.

The content and generation method of the key data may refer to the detailed description of Step S10211 above and will not be repeated here.

After the client device decrypts the target processing result, the decrypted target processing result may be displayed and output on the window interface of the first application, that is, displayed on the window interface of the first application that establishes a connection with the first device and the target processing device.

After the client device decrypts the target processing result, the client device may also display the decrypted data on the current display interface of the client device. Here, the current display interface refers to a display interface of the application used to generate the target processing task and call the first application, such as WeChat®, QQ®, Teams® and other applications.

Step S1032: When the target processing task is not a single task, multiple corresponding target processing results are displayed and output to a same input area or different input areas of the client device respectively, and the different input areas belong to or do not belong to a same application.

Here, in the case where the target processing task is not a single task, the client device receives the multiple corresponding target processing results from the target processing device.

Displaying and outputting the corresponding multiple processing results to a same input area or different input areas of the client device respectively means displaying the corresponding target processing results at the initiation positions of the corresponding target processing tasks according to the initiation positions of different target processing tasks.

For example, when different target processing tasks are initiated in a same session window of the same application, the multiple target processing results are displayed in the same session window of the application that initiated the target processing tasks.

For example, when different target processing tasks are initiated in different session windows of the same application, the multiple target processing results are respectively displayed in the corresponding session windows that initiated the corresponding target processing tasks in the application.

For example, when different target processing tasks are initiated by different applications, the multiple target processing results are respectively displayed in the session windows of the applications corresponding to the initiators of the corresponding target processing tasks.

In this way, by displaying multiple target processing results in the initiation windows of the corresponding target processing tasks, a user may view the corresponding target processing results in the initiation windows of the target processing tasks without jumping to the first application or other applications, thereby providing the user with a seamless experience of initiating processing tasks and receiving processing results.

Step S1033: Use the key data exchanged with the target processing device to decrypt the target processing result fed back by the target processing device, and send the decrypted target processing result to an associated device of the client device, so as to use the associated device to display and output the decrypted target processing result, where the associated device is a device that establishes a third connection with the client device.

In some embodiments, before the client device receives the target processing result from the target processing device, the client device may exchange key data with the target processing device so that the target processing device may encrypt the target processing result based on the exchanged key data and feed back the encrypted target processing result to the client device through the second connection.

The content and generation method of the key data may refer to the detailed description of Step S10211 above and will not be repeated here.

After the client device decrypts the target processing result, the decrypted target processing result may be sent to an associated device of the client device, so that the associated device may display and output the target processing result.

Here, the associated device may refer to a screen expansion device, a screen projection device, etc., that establishes a third connection with the client device, or a device connected via Bluetooth, Wi-Fi, etc. Here, there is no specific limitation on the type of associated device and the connection method with the client device.

In another aspect, the present disclosure also provides another data processing method applied to a first processing device, which may be executed by a processor of the first processing device. The first processing device may refer to a server, a laptop, a tablet, a desktop computer, a smart TV, a set-top box, a mobile device (such as a mobile phone, a portable video player, a personal digital assistant, a dedicated messaging device, a portable gaming device), or other devices with data processing capabilities.

FIG. 2 is a flowchart of another data processing method provided by the present disclosure. As shown in FIG. 2, the method includes the following Steps S201 to S203.

Step S201: After establishing a second connection with a client device, receive a target processing task sent by the client device.

Here, the process of the first processing device establishing a second connection with the client device and receiving the target processing task from the client device corresponds to the process of the client device establishing a second connection with the target processing device and sending the target processing task to the target processing device through the second connection in the above Step S102. During implementation, the above Step S102 may be referred to.

Step S202: Process the target processing task with a corresponding processing strategy based on the task information of the target processing task.

Here, the task information of the target processing task may include the computing power requirement, computing amount, estimated execution time, task type, and so on corresponding to the target processing task.

In some embodiments, the target processing task information may also include information on whether the target processing task is splitable.

In this way, the first processing device determines the corresponding processing strategy according to information such as the computing power requirement, computing amount, expected execution time, task type and whether the target processing task may be split.

For example, when the target processing task has a high computing power requirement, a large amount of calculation, an expected long execution time and may be split, the target processing task may be split into multiple sub-tasks, and some of the split sub-tasks may be assigned to other processing devices in the device group for processing. For another example, when the target processing task has a low computing power requirement, a low amount of calculation, and a low expected execution time, the target processing task may be processed by the first processing device alone.

Step S203: Encrypt the target processing result of the target processing task and send the encrypted target processing result to the client device through the second connection.

The second connection is established by the client device based on the first device information of the first processing device, and the first device information is obtained by the client device, from the device information of each processing device in the device group where the first device is located, through the first connection between the client device and the first device.

The first connection is different from the second connection, and the client device and the processing device are in a same network or in different networks.

In some embodiments, the above Step S203 is a step corresponding to the above Steps S101 to S103 and at least one of Steps S10212, S1031 and S1033. When implemented, the above Steps S101 to S103 and Steps S10212, S1031 and S1033 may be referred to.

In the above data processing methods provided by the present disclosure, after the first processing device receives the target processing task from the client device through the second connection, the first processing device processes the target processing task with the corresponding processing strategy based on the task information of the target processing task, and encrypts the target processing result for the target processing task and sends the encrypted task processing result to the client device through the second connection. Here, the second connection is established by the client device based on the first device information of the first processing device, and the first device information is obtained by the client device from the device information of each processing device in the device group where the first device is located through the first connection between the client device and the first device.

The first connection is different from the second connection, and the client device and the processing device are in the same network or different networks. In this way, the target processing task sent by the client device is processed by the first processing device, and the first device manages at least one processing device in the device group, so as to optimize the resource utilization of each processing device in the device group. At the same time, the first processing device selects a corresponding processing strategy to process the target processing task according to the task information of the target processing task, so that the selected processing strategy may be more matched with the target processing task, thereby improving the processing efficiency of the target processing task. In addition, the first connection between the client device and the first device is different from the second connection between the client device and the first processing device. That is, different connection methods are used to realize the transmission of device information and the transmission of target processing tasks, which increases the complexity of network connection, and thus improves the security of data transmission, especially when the second connection is a P2P connection. This may also improve the transmission efficiency and security of the target processing task.

In some embodiments, the target processing task being processed with a corresponding processing strategy based on the task information of the target processing task (i.e., Step S202) may be implemented as at least one of the following Steps S2021 to S2023.

Step S2021: When the task information matches a functional service and/or hardware resources configured in the first processing device, call a target functional service or a local target model to process the target processing task.

Here, the functional service may refer to a functional service provided by the first processing device using an installed data processing application.

For example, in the case where the first processing device is installed with an AI application for implementing text-to-image generation, such as a diffusion model, the first processing device is configured with a text-to-image service.

For example, when the first processing device is installed with an AI application for implementing image recognition, such as a YOLO® (You Only Look Once) series, the first processing device is configured with an image recognition service.

Hardware resources may refer to the hardware configuration of the first processing device, such as the configuration of CPU, GPU, memory, etc. Based on the hardware resources, the computing power of the first processing device may be determined.

At the same time, it is possible to determine how much hardware resources the first processing device may allocate to execute the target processing task based on the current status of tasks to be processed by the first processing device, for example, the status of tasks queued in the task queue of the first processing device.

In this way, when the functional services and/or hardware resources configured by the first processing device match, a target functional service or target model corresponding to the target processing task may be called to process the target processing task. That is, the hardware and/or software resources of the first processing device itself may be used to complete the target processing task.

Step S2022: If the task information does not match the functional services configured on the first processing device, send the target processing task to at least one fourth processing device in the device group for processing.

In some embodiments, the task information of the target processing task does not match the functional services configured by the first processing device. That is, the first processing device does not install an application corresponding to the functional service required by the target processing task, resulting in the first processing device being unable to process the target processing task.

In some embodiments, the first processing device determines at least one fourth processing device configured with a functional service matching the task information of the target processing task based on the device information corresponding to other processing devices in the device group, and sends the target processing task to each fourth processing device.

In some embodiments, the first processing device obtains device network information of each fourth processing device in the device group from the first device, and establishes a network connection with each fourth processing device based on the device network information.

In some embodiments, when the first processing device supports point-to-point connection (e.g., P2P connection), for each fourth processing device that supports the same type of point-to-point connection, the first processing device establishes a point-to-point connection (e.g., P2P connection) with the fourth processing device, and sends at least a portion of the target processing task to the corresponding fourth processing device through the point-to-point connection. At the same time, for each fourth processing device that does not support the same type of point-to-point connection, the first processing device sends at least a portion of the target processing task to the first device, which is forwarded by the first device to the corresponding fourth processing device.

In some embodiments, the first processing device splits the target processing task based on the hardware resources of each fourth processing device to obtain multiple subtasks, and allocates a subtask matching the hardware resource situation of each fourth processing device. Here, the principle of the first processing device splitting the target processing task and matching a fourth processing device with a subtask is to minimize the total processing time of the target processing task.

Step S2023: When the task information does not match the hardware resources configured in the first processing device, portion of the target processing task is sent to at least one fifth processing device in the device group, to cooperate with the fifth processing device to execute the target processing task.

In some embodiments, the task information of the target processing task does not match the hardware resources configured by the first processing device. That is, the hardware resources configured by the first processing device do not meet the hardware resource conditions required by the target processing task, resulting in the first processing device being unable to process the target processing task.

Similar to the above Step S2022, the first processing device may establish a point-to-point connection with the fifth processing device to send at least a portion of the target processing task to the corresponding fifth processing device. Alternatively, the first processing device may forward at least a portion of the target processing task to the corresponding fifth processing device through the first device.

In some embodiments, the first processing device splits the target processing task process based on the hardware resources of each fifth processing device to obtain multiple subtasks, and allocates a subtask matching its hardware resource situation to each fifth processing device. Here, the principle of the first processing device splitting the target processing task and matching a fifth processing device with a subtask is to minimize the total processing time of the target processing task.

Step S2024: When the target processing task is not a single task, at least some of the multiple processing tasks are sent to at least one sixth processing device in the device group, so as to cooperate with the sixth processing device to execute the multiple processing tasks.

Here, when the target processing task is not a single task, the first processing device may send at least a portion of the target processing task to at least one sixth processing device in the device group according to the functional services and/or hardware resources configured by other processing devices in the device group.

In some embodiments, the first processing device determines the execution time required for each processing device to process each target processing task based on the functional service and/or hardware resource information configured for each processing device obtained from the first device, and the functional services and hardware resources required for each target processing task, and determines a group of processing devices, with the shortest total execution time for all target processing tasks, as the at least one sixth processing device.

In some embodiments, each target processing task has corresponding priority information. In this way, the first processing device allocates a processing device with a higher hardware resource configuration to a target processing task with a higher priority according to the functional service and/or hardware resource information of each processing device configuration obtained from the first device and according to the priority information of each target processing task, so as to improve the processing efficiency of the high-priority target processing tasks.

Similar to the above Step S2022, the first processing device may establish a point-to-point connection with a sixth processing device to send the corresponding target processing task to the corresponding sixth processing device. Alternatively, the first processing device may forward the target processing task to the corresponding sixth processing device through the first device.

In the above embodiments, the first processing device determines whether to execute the target processing task independently or in collaboration with other processing devices based on the hardware resources and/or functional services configured by itself and other processing devices in the device group, as well as the task information of the target processing task, so as to shorten the processing time of the target processing task. This improves the processing efficiency of the target processing task, and thereby improving the user experience.

In some embodiments, encrypting and sending the target processing result for the target processing task to the client device through the second connection (i.e., Step S203) may be implemented as at least one of the following Steps S2031 to S2032.

Step S2031: Process the processing results fed back by the fourth processing device and/or the fifth processing device into target processing results, encrypt the target processing results and send the encrypted target processing results to the client device through the second connection.

Here, when the first processing device splits the target processing task and sends at least part of the split target processing task to the fourth processing device and/or the fifth processing device for processing, the first processing device receives the corresponding processing results from the fourth processing device and/or the fifth processing device, and integrates the multiple processing results to obtain a target processing result.

In some embodiments, the first application installed on the first processing device may be used to integrate the processing results fed back by the fourth processing device and/or the fifth processing device to obtain the target processing result.

In some embodiments, the processing results fed back by the fourth processing device and/or the fifth processing device may be integrated using the functional service corresponding to the target processing task installed on the first processing device to obtain the target processing result.

In some embodiments, the first processing device and the client device pre-agree on key data to encrypt the target processing result using the key data. Here, the key data may include an encryption suite and a key, where the method for determining the key may refer to the specific implementation method in Step S10211.

In this way, the first processing device sends the encrypted target processing result to the client device through the second connection to improve the transmission security of the target processing result.

Step S2032: Send the device network information of the client device to a sixth processing device, so that the sixth processing device establishes a third connection with the client device, and the sixth processing device sends a processing result obtained by processing the corresponding processing task to the client device through the third connection.

Here, when the first processing device sends a target processing task to at least one sixth processing device for processing, the first processing device may send the device network information of the client device to each sixth processing device, so that each sixth processing device establishes a third connection with the client device based on the device network information, so as to send the processing result to the client device through the third connection.

In some embodiments, the third connection is a point-to-point connection (e.g., a P2P connection) between the client device and each sixth processing device.

In some embodiments, the client device or the first processing device sends the key data to each sixth processing device respectively, so that the sixth processing device uses the key data to encrypt the respective processing result and sends the encrypted processing result to the client device through the third connection.

In this way, by establishing a third connection between the client device and each sixth processing device, the sixth processing device may send the corresponding processing result directly to the client device, reducing data transmission nodes and shortening data transmission time, thereby improving data transmission security and transmission efficiency.

Hereinafter, a network architecture on which the data processing method provided in the present disclosure is implemented is described in conjunction with FIG. 3.

As shown in FIG. 3, the network architecture based on the data processing method provided by the present disclosure involves a client device 310, a first device 320, a first intranet device 330, a second intranet device 340, and a public network port 350, a public network port 360, an intranet port 370 and an intranet port 380.

Here, the client device 310 may be a user's tablet, mobile phone or other electronic device. The first device 320 may be a host device or a main control device set in the public network. The first intranet device 330 and the second intranet device 340 may be electronic devices that provide specified functional services, for example, an AI PC that may provide AI reasoning services.

In this way, the process of using the above devices to establish a network architecture for implementing the data processing method provided in the present disclosure may include the following Steps S301 to S304.

Step S301: The client device 310, the first device 320, the first intranet device 330 and the second intranet device 330 are all installed with a first application for realizing device interconnection.

Step S302: The client device 310 establishes a long connection with the first device 320 through the first application via the public network port 350 or the public network port 360, the first intranet device 330 establishes a long connection with the first device 320 through the first application via the intranet port 370, and the second intranet device 340 establishes a long connection with the first device 320 through the first application via the intranet port 380.

Step S303: The first device 320 queries the account information of the client device 310, the first intranet device 330 and the second intranet device 340 for logging into the first application, and after confirming that the client device 310, the first intranet device 330 and the second intranet device 340 log into the same account, the client device 310, the first intranet device 330 and the second intranet device 340 are placed in a same device room, thereby completing the networking.

Step S304: The first device 320 collects and records the network status information of the client device 310, the first device 320, the first intranet device 330, and the second intranet device 340 (i.e., whether intranet penetration is supported).

Thus, after the network is established through the above Steps S301 to S304, an embodiment of the data processing method provided by the present disclosure using the above network architecture may include the following Steps S305 to S308.

Step S305: After obtaining a text-to-image task, the client device 310 accesses the public network port 350 or the public network port 360, and initiates a task processing request to the first device 320 through the public network port 350 or the public network port 360; then, proceed to Step S306.

Step S306: After receiving the task processing request initiated by the client device 310, the first device 320 collects the device information of the first intranet device 330 and the second intranet device 340; then, proceed to Step S307.

Step S307: The first intranet device 330 sends its device information to the first device 320 via the intranet port 370, and the second intranet device 340 sends its device information to the first device 320 via the intranet port 380; then, proceed to Step S308.

Step S308: The first device sends the device information sent by the first intranet device 330 and the second intranet device 340 to the client device 310 through the public network port 350 or the public network port 360; then, proceed to Step S309.

Step S309: The client device 310 determines a target processing device from the first intranet device 330 and the second intranet device 340 based on the task type and required hardware resources of the text-to-image task and the device information sent by the first intranet device 330 and the second intranet device 340; then, proceed to Step S3010.

In one example, the client device 310 determines the first intranet device 330 as the target processing device.

Step S3010: The client device 310 sends the target processing device information to the first device 320; then, proceed to Step S3011.

Step S3011: After the first device 320 determines that the first intranet device 330 is the target processing device, the first device 320 sends the network status information of the first intranet device 330 to the client device 310; then, proceed to Step S2012.

Step S3012: The client device 310 determines that the first intranet device 330 supports intranet penetration based on the network status information of the first intranet device 330. Therefore, the first intranet device 330 establishes a P2P connection with the first intranet device 330 based on the P2P TCP protocol, and sends the text generation image task to the first intranet device 330 through the P2P connection. Then, proceed to Step S3013.

Step S3013: The first intranet device 330 determines that it may independently complete the text-to-image task based on its own configured functional services and hardware resources and the functional services and hardware resource requirements of the target processing task; the first intranet device 330 executes the text-to-image task and obtains an image generation result; then, proceed to Step S3014.

Step S3014: The first intranet device 330 sends the image generation result to the client device 310 via the P2P connection; and the client device 310 displays and outputs the generated image.

Based on the foregoing embodiments, the embodiments of the present disclosure provide a data processing device disposed in a client device. The units included in the data processing device and the modules included in the units, may be implemented by a processor in a computer device. Apparently, the modules and units may also be implemented by a specific logic circuit. In the implementation process, the processor may be a central processing unit (CPU), a microprocessor (MPU), a digital signal processor (DSP) or a field programmable gate array (FPGA), etc.

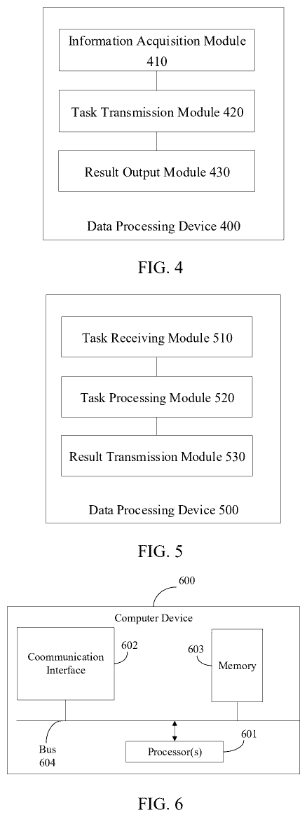

FIG. 4 is a schematic diagram of the system architecture of a data processing device provided in a client device according to an embodiment of the present disclosure. As shown in FIG. 4, the data processing device 400 includes an information acquisition module 410, a task transmission module 420 and a result output module 430.

The information acquisition module 410 is configured to obtain device information of each processing device in the device group where the first device is located after establishing a first connection with the first device.

The task transmission module 420 is configured to establish a second connection with a target processing device in the device group based on the device information, and send a target processing task to the target processing device through the second connection.

The result output module 430 is configured to output a target processing result for the target processing task fed back by the target processing device through the second connection.

The first connection is different from the second connection, and the client device and the processing device are in a same network or in different networks.

In some embodiments, the information acquisition module 410 is configured to perform at least one of the following.

After the client device establishes a first connection with the first device through the first application, display the device information of each processing device in the device group on a window interface of the first application.

In response to the client device running the first application, establish a first connection with the first device, display each processing device in the device group managed by the first device in a window interface of the first application, and display device information of the corresponding processing device in response to a trigger operation acting on the window interface.

In response to obtaining the target processing task, establish a first connection with the first device to obtain device information of each processing device through the first connection, or display the device information of the processing device on a current display interface of the client device.

In response to obtaining target interactive content in a second application, trigger the client device to run the first application to establish a first connection with the first device to obtain device information of each processing device through the first connection, or display the device information of the processing device in a window interface of the second application.

In some embodiments, the task transmission module 420 includes a connection establishing module 421.

The connection establishing module 421 is configured to perform at least one of the following.

Determine a target processing device from the device group, and establish a second connection based on device network information of the target processing device.

In response to receiving a target processing device recommended by the first device, establish a second connection based on the device network information of the target processing device.

Determine a target processing device from the device group, and establish a second connection based on device identification information of the target processing device.

In response to receiving a target processing device recommended by the first device, establish a second connection based on the device identification information of the target processing device.

The second connection may be a point-to-point connection between the client device and the target processing device.

In some embodiments, the connection establishing module 421 is configured to perform at least one of the following.

Sort the processing devices based on the device configuration information and the current operation information of the devices provided by the first device, and determine a first processing device in the top category as the target processing device.

Obtain task information of the target processing task, and determine a second processing device in the device group, that may provide a functional service matching the task information, as the target processing device.

Determine a target processing device from the device group based on network configuration information and/or current network status information of each processing device.

Obtain user profile information of a target user, and determine a target processing device from the device group based on the user profile information.

Obtain a selection operation of a target user, and determine a third processing device, in the device group, that matches the selection operation as the target processing device.

In some embodiments, the task transmission module 420 is further configured to perform one of the following.

After determining the target processing device, feeding back the device identification information of the target processing device to the first device, so that the first device updates the device information of the processing devices in the device group;

In the case where the second connection cannot be established with the target processing device, using the first device to send the target processing task to the target processing device;

The key data is exchanged with the target processing device, and the target processing task is encrypted by using the key data and then sent to the target processing device through the second connection, where the target processing task includes at least one processing task, and different processing tasks correspond to different key data.

In some embodiments, the result output module 430 is configured to perform at least one of the following:

Decrypt a target processing result fed back by the target processing device by using key data exchanged with the target processing device, and display and output the decrypted target processing result on a window interface of the first application or the current display interface of the client device.

In the case where the target processing task is not a single task, respectively display and output multiple corresponding target processing results to a same input area or different input areas of the client device, and the different input areas belong to or do not belong to a same application.

Decrypt the target processing result fed back by the target processing device using the key data exchanged with the target processing device, and send the decrypted target processing result to an associated device of the client device, so that the decrypted target processing result is displayed and output by the associated device, where the associated device is a device that establishes a third connection with the client device.

Based on the foregoing embodiments, the embodiments of the present disclosure provide a data processing device disposed on a first processing device. The units included in the data processing device and the modules included in the units may be implemented by a processor in a computer device. Apparently, these units and modules may also be implemented by a specific logic circuit. In the implementation process, the processor may be a CPU, an MPU, a DSP or an FPGA, etc.

FIG. 5 is a schematic diagram of the system architecture of a data processing device provided on a first processing device according to an embodiment of the present disclosure. As shown in FIG. 5, the data processing device 500 includes a task receiving module 510, a task processing module 520 and a result transmission module 530.

The task receiving module 510 is configured to receive a target processing task sent by the client device after establishing a second connection with the client device.

The task processing module 520 is configured to process the target processing task with a corresponding processing strategy based on the task information of the target processing task.

The result transmission module 530 is configured to encrypt the target processing result of the target processing task and send the result to the client device through the second connection.

The second connection is established by the client device based on the first device information of the first processing device, and the first device information is obtained by the client device from the device information of each processing device in the device group where the first device is located through the first connection between the client device and the first device.

The first connection is different from the second connection, and the client device and the processing device are in a same network or in different networks.

In some embodiments, the task processing module 520 is configured to perform at least one of the following.

In the case where the task information matches the functional service and/or hardware resources configured by the first processing device, call a target functional service or the local target model to process the target processing task.

In the case where the task information does not match the functional services configured by the first processing device, send the target processing task to at least one fourth processing device in the device group for processing.

In the case where the task information does not match the hardware resources of the first processing device, send a portion of the target processing task to at least one fifth processing device in the device group, so as to cooperate with the fifth processing device to perform the target processing task.

In the case that the target processing task is not a single task, at least some of the multiple processing tasks are sent to at least one sixth processing device in the device group, so as to cooperate with the sixth processing device to execute the multiple processing tasks.

In some embodiments, the result transmission module 530 is configured to perform at least one of the following.

Process the obtained processing results fed back by the fourth processing device and/or the fifth processing device into a target processing result, encrypt the target processing result and send the encrypted target processing result to the client device through the second connection.

Send the device network information of the client device to the sixth processing device, so that the sixth processing device establishes a third connection with the client device, and the sixth processing device sends the processing result obtained by processing the corresponding processing task to the client device through the third connection.

The descriptions of the above device embodiments are similar to the descriptions of the above method embodiments, and have similar beneficial effects as the method embodiments. In some embodiments, the functions or modules included in the device provided by the embodiments of the present disclosure may be used to execute the methods described in the above method embodiments. For technical details not disclosed in the device embodiments of the present disclosure, refer to the descriptions of the method embodiments of the present disclosure for understanding.

In some embodiments, the present disclosure also provides a client device.

The client device provided in the present disclosure includes a processor and a storage device, where the storage device stores a computer program that may be run on the processor, where the processor is configured to: after establishing a first connection with a first device, obtain device information of each processing device in a device group where the first device is located; establish a second connection with a target processing device in the device group based on the device information, and send a target processing task to the target processing device through the second connection; output a target processing result for the target processing task fed back by the target processing device through the second connection, where the first connection is different from the second connection, and the client device and the processing device are in a same network or different networks.

In some embodiments, the present disclosure also provides a first processing device.

The present disclosure provides a first processing device including a processor and a storage device. The storage device stores a computer program that may be run on the processor, where the processor is configured to: after establishing a second connection with the client device, receive a target processing task sent by the client device; process the target processing task with a corresponding processing strategy based on the task information of the target processing task; encrypt the target processing result of the target processing task and send the encrypted target processing result to the client device through the second connection.

The second connection is established by the client device based on the first device information of the first processing device, and the first device information is obtained by the client device from the device information of each processing device in the device group where the first device is located through the first connection between the client device and the first device.

The first connection is different from the second connection, and the client device and the processing device are in a same network or in different networks.

It should be noted that the processors in the above client device and the first processing device may be configured to respectively execute part or all of the steps related to the client device and the first processing device in the above method embodiments.

It should be noted that in the embodiments of the present disclosure, if the above data processing methods are implemented in the form of software function modules and sold or used as an independent product, the software function modules may also be stored in a computer-readable storage medium. Based on this understanding, the technical solutions of the embodiments of the present disclosure may be essentially or partly embodied in the form of a software product that contributes to the relevant technology. The software product is stored in a storage medium, including several instructions to enable a computer device (which may be a personal computer, a server, or a network device, etc.) to execute all or part of the methods described in each embodiment of the present disclosure. The aforementioned storage medium includes various media that may store program codes, such as a U disk, a mobile hard disk, a read-only memory (ROM), a disk or an optical disk. In this way, the embodiments of the present disclosure are not limited to any specific hardware, software or firmware, or any combination of hardware, software, and firmware.

Embodiments of the present disclosure provide a computer device, including a memory and a processor, where the memory stores a computer program that may be run on the processor, and when the processor executes the program, some or all of the steps in the above methods are implemented.

Embodiments of the present disclosure provide a computer-readable storage medium on which a computer program is stored, and when the computer program is executed by a processor, some or all of the steps in the above methods are implemented. The computer-readable storage medium may be transient or non-transient.

Embodiments of the present disclosure provide a computer program, including a computer-readable code. When the computer-readable code is run in a computer device, a processor in the computer device executes some or all of the steps for implementing the above methods.

Embodiments of the present disclosure provide a computer program product, which includes a non-transitory computer-readable storage medium storing a computer program, and when the computer program is read and executed by a computer, some or all of the steps in the above methods are implemented. The computer program product may be implemented in hardware, software, or a combination thereof. In some embodiments, the computer program product is specifically embodied as a computer storage medium, and in other embodiments, the computer program product is specifically embodied as a software product, such as a software development kit (SDK), etc.

It should be noted here that the description of the various embodiments above tends to emphasize the differences between the various embodiments, and the same or similar aspects may be referenced to each other. The description of the above device, storage medium, computer program and computer program product embodiments is similar to the description of the above method embodiments, and has similar beneficial effects as the method embodiments. For technical details not disclosed in the embodiments of the device, storage medium, computer program and computer program product of the present disclosure, refer to the description of the method embodiments of the present disclosure for understanding.

It should be noted that FIG. 6 is a schematic diagram of hardware entities of a computer device in an embodiment of the present disclosure. As shown in FIG. 6, the hardware entity of the computer device 600 includes a processor 601, a communication interface 602, and a memory 603.

Processor 601 generally controls the overall operation of computer device 600.

The communication interface 602 enables the computer device to communicate with other terminals or servers through a network.

The memory 603 is configured to store instructions and applications executable by the processor 601, and may also cache data to be processed or processed by the processor 601 and various modules in the computer device 600 (e.g., image data, audio data, voice communication data, and video communication data), which may be accessed through a flash memory or a RAM. The processor 601, the communication interface 602 and the memory 603 may transmit data via a bus 604.

It should be understood that “one embodiment” or “an embodiment” mentioned throughout the specification means that specific features, structures or characteristics related to the embodiment are included in at least one embodiment of the present disclosure. Therefore, “in one embodiment” or “in an embodiment” appearing throughout the specification does not necessarily refer to the same embodiment. In addition, these specific features, structures or characteristics may be combined in one or more embodiments in any suitable manner. It should be understood that in various embodiments of the present disclosure, the value of the serial number of each step/process mentioned above does not mean the order of execution, and the execution order of each step/process should be determined by its function and internal logic, and should not constitute any limitation on the implementation process of the embodiments of the present disclosure. The serial numbers of the embodiments of the present disclosure mentioned above are merely for description and do not represent the advantages and disadvantages of the embodiments of the present disclosure.

It should be noted that, in this disclosure, the terms “include”, “comprise” or any other variations thereof are intended to cover non-exclusive inclusion, so that a process, method, article or device including a series of elements includes not only those elements, but also other elements not explicitly listed, or also includes elements inherent to such process, method, article or device. In the absence of further restrictions, an element defined by the sentence “comprises a . . . ” does not exclude the existence of other identical elements in the process, method, article or device including the element.

In the specific embodiments provided in the present disclosure, it should be understood that the disclosed devices and methods may be implemented in other ways. The device embodiments described above are merely schematic. For example, the division of the units is only a logical function division. There may be other division methods in actual implementation, such as multiple units or components may be combined, or may be integrated into another system, or some features may be ignored or not executed. In addition, the coupling, direct coupling, or communication connection between the components shown or discussed may be through some interfaces, and the indirect coupling or communication connection of the devices or units may be electrical, mechanical or other forms.

The units described above as separate components may or may not be physically separated, and the components displayed as units may or may not be physical units. These units or components may be located in one place or distributed on multiple network units. Some or all of the units may be selected according to actual needs to achieve the objectives of the present disclosure.

In some embodiments, all functional units in the embodiments of the present disclosure may be integrated into one processing unit, or each unit may be a separate unit, or two or more units may be integrated into one unit. The integrated units may be implemented in the form of hardware or in the form of hardware plus software functional units.

A person skilled in the art may understand that all or part of the steps of implementing the above method embodiments may be completed by hardware related to program instructions, and the aforementioned program may be stored in a computer-readable storage medium. When the program is executed, it executes the steps of the above method embodiments. The aforementioned storage medium includes various media that may store program codes, such as mobile storage devices, ROM, magnetic disks or optical disks.

In some embodiments, if the above integrated units of the present disclosure are implemented in the form of software function modules and sold or used as an independent product, the software function modules may also be stored in a computer-readable storage medium. Based on this understanding, the technical solutions of the present disclosure may essentially or in other words, the part that contributes to the relevant technology may be embodied in the form of a software product, which is stored in a storage medium and includes a number of instructions for a computer device (which may be a personal computer, server, or network device, etc.) to execute all or part of the methods described in each embodiment of the present disclosure. The aforementioned storage medium includes various media that may store program codes, such as mobile storage devices, ROMs, magnetic disks, or optical disks.

The foregoing description includes some specific embodiments of the present disclosure, but the protection scope of the present disclosure is not limited thereto. A person skilled in the art may easily think of changes or substitutions within the technical scope disclosed in the present disclosure, which should be included in the protection scope of the present disclosure.

What is claimed is:

1. A data processing method, applied to a client device, and the method comprising:
after establishing a first connection with a first device, obtaining device information of each processing device in a device group where the first device is located;
establishing a second connection with a target processing device in the device group based on the device information, and sending a target processing task to the target processing device through the second connection; and
outputting a target processing result for the target processing task fed back by the target processing device through the second connection,
wherein the first connection is different from the second connection, and the client device and the processing device are in a same network or in different networks.

2. The method according to claim 1, wherein obtaining the device information of each processing device in the device group where the first device is located comprises at least one of following:
after the client device establishes the first connection with the first device through a first application, displaying the device information of each processing device in the device group on a window interface of the first application;
in response to the client device running the first application, establishing the first connection with the first device, displaying each processing device in the device group managed by the first device in the window interface of the first application, and displaying device information of a corresponding processing device in response to a trigger operation acting on the window interface;
in response to obtaining the target processing task, establishing the first connection with the first device to obtain the device information of each processing device through the first connection, or displaying the device information of each processing device on a current display interface of the client device; or
in response to obtaining target interactive content in a second application, triggering the client device to run the first application to establish the first connection with the first device to obtain the device information of each processing device through the first connection, or displaying the device information of each processing device in a window interface of the second application.

3. The method according to claim 1, wherein establishing the second connection with the target processing device in the device group based on the device information comprises at least one of following:
determining the target processing device from the device group, and establishing the second connection based on device network information of the target processing device;
in response to accepting a target processing device recommended by the first device, establishing the second connection based on the device network information of the target processing device;
determining the target processing device from the device group, and establishing the second connection based on device identification information of the target processing device; or
in response to accepting the target processing device recommended by the first device, establishing the second connection based on the device identification information of the target processing device,
wherein the second connection is a point-to-point connection between the client device and the target processing device.

4. The method according to claim 3, wherein determining the target processing device from the device group comprises at least one of following:
sorting processing devices based on device configuration information and current operation information of the processing devices provided by the first device, and determining a first processing device in a top category as the target processing device;
obtaining task information of the target processing task, and determining a second processing device, in the device group, that is able to provide a functional service matching the task information as the target processing device;
determining the target processing device from the device group based on network configuration information and/or current network status information of each processing device;
obtaining user profile information of a target user, and determining the target processing device from the device group based on the user profile information; or
obtaining a selection operation of the target user, and determining a third processing device, in the device group, that matches the selection operation as the target processing device.

5. The method according to claim 1, further comprising at least one of following:
after determining the target processing device, feeding back device identification information of the target processing device to the first device, so that the first device updates the device information of each processing device in the device group;
when the second connection cannot be established with the target processing device, using the first device to send the target processing task to the target processing device; or,
sending the target processing task to the target processing device through the second connection includes:
exchanging key data with the target processing device, and encrypting the target processing task by using the key data and then sending the encrypted target processing task to the target processing device through the second connection, wherein the target processing task includes at least one processing task, and different processing tasks correspond to different key data.

6. The method according to claim 1, wherein outputting the target processing result for the target processing task fed back by the target processing device through the second connection comprises at least one of following:
decrypting the target processing result fed back by the target processing device by using the key data exchanged with the target processing device, and displaying and outputting the decrypted target processing result on a window interface of a first application or a current display interface of the client device;
when the target processing task is not a single task, respectively displaying and outputting multiple corresponding processing results to a same input area or different input areas of the client device, wherein the different input areas belong to or do not belong to a same application; or
decrypting the target processing result fed back by the target processing device using the key data exchanged with the target processing device, and sending the decrypted target processing result to an associated device of the client device, so that the decrypted target processing result is displayed and output by the associated device, wherein the associated device is a device that establishes a third connection with the client device.

7. A data processing method, applied to a first processing device, and the method comprising:
after establishing a second connection with a client device, receiving a target processing task sent by the client device;
processing the target processing task with a corresponding processing strategy based on task information of the target processing task; and
encrypting a target processing result of the target processing task and sending the encrypted target processing result to the client device through the second connection,
wherein the second connection is established by the client device based on first device information of the first processing device, and the first device information is obtained by the client device, from device information of each processing device in a device group where a first device is located, through a first connection between the client device and the first device, and
wherein the first connection is different from the second connection, and the client device and the first processing device are in a same network or in different networks.

8. The method according to claim 7, wherein processing the target processing task with the corresponding processing strategy based on the task information of the target processing task comprises at least one of following:
when the task information matches a functional service and/or hardware resources configured by the first processing device, calling a target functional service or a local target model to process the target processing task;
when the task information does not match functional services configured by the first processing device, sending the target processing task to at least one fourth processing device in the device group for processing;
when the task information does not match the hardware resources configured by the first processing device, sending a portion of the target processing task to at least one fifth processing device in the device group, so as to cooperate with the fifth processing device to perform the target processing task; or
when the target processing task is not a single task, sending at least some of multiple processing tasks to at least one sixth processing device in the device group, so as to cooperate with the sixth processing device to execute the multiple processing tasks.

9. The method according to claim 7, wherein encrypting the target processing result of the target processing task and sending the encrypted target processing result to the client device through the second connection comprises at least one of following:
processing obtained processing results fed back by the fourth processing device and/or the fifth processing device into the target processing result, encrypting the target processing result and sending the encrypted target processing result to the client device through the second connection; or
sending device network information of the client device to a sixth processing device, so that the sixth processing device establishes a third connection with the client device, and the sixth processing device sends the target processing result obtained by processing the corresponding processing task to the client device through the third connection.

10. An electronic device, comprising one or more processors and a memory containing a computer program that, when being executed, causes the one or more processors to perform:
after establishing a first connection with a first device, obtaining device information of each processing device in a device group where the first device is located;
establishing a second connection with a target processing device in the device group based on the device information, and sending a target processing task to the target processing device through the second connection; and
outputting a target processing result for the target processing task fed back by the target processing device through the second connection,
wherein the first connection is different from the second connection, and the client device and the processing device are in a same network or in different networks.

11. The electronic device according to claim 10, wherein the one or more processors are further caused to perform at least one of following:
after the client device establishes the first connection with the first device through a first application, displaying the device information of each processing device in the device group on a window interface of the first application;
in response to the client device running the first application, establishing the first connection with the first device, displaying each processing device in the device group managed by the first device in the window interface of the first application, and displaying device information of a corresponding processing device in response to a trigger operation acting on the window interface;
in response to obtaining the target processing task, establishing the first connection with the first device to obtain the device information of each processing device through the first connection, or displaying the device information of each processing device on a current display interface of the client device; or
in response to obtaining target interactive content in a second application, triggering the client device to run the first application to establish the first connection with the first device to obtain the device information of each processing device through the first connection, or displaying the device information of each processing device in a window interface of the second application.

12. The electronic device according to claim 10, wherein the one or more processors are further caused to perform at least one of following:
determining the target processing device from the device group, and establishing the second connection based on device network information of the target processing device;
in response to accepting a target processing device recommended by the first device, establishing the second connection based on the device network information of the target processing device;
determining the target processing device from the device group, and establishing the second connection based on device identification information of the target processing device; or
in response to accepting the target processing device recommended by the first device, establishing the second connection based on the device identification information of the target processing device,
wherein the second connection is a point-to-point connection between the client device and the target processing device.

13. The electronic device according to claim 12, wherein the one or more processors are further caused to perform at least one of following:
sorting processing devices based on device configuration information and current operation information of the processing devices provided by the first device, and determining a first processing device in a top category as the target processing device;
obtaining task information of the target processing task, and determining a second processing device, in the device group, that is able to provide a functional service matching the task information as the target processing device;
determining the target processing device from the device group based on network configuration information and/or current network status information of each processing device;
obtaining user profile information of a target user, and determining the target processing device from the device group based on the user profile information; or
obtaining a selection operation of the target user, and determining a third processing device, in the device group, that matches the selection operation as the target processing device.

14. The electronic device according to claim 10, wherein the one or more processors are further caused to perform at least one of following:
after determining the target processing device, feeding back device identification information of the target processing device to the first device, so that the first device updates the device information of each processing device in the device group;
when the second connection cannot be established with the target processing device, using the first device to send the target processing task to the target processing device; or,
sending the target processing task to the target processing device through the second connection includes:
exchanging key data with the target processing device, and encrypting the target processing task by using the key data and then sending the encrypted target processing task to the target processing device through the second connection, wherein the target processing task includes at least one processing task, and different processing tasks correspond to different key data.

15. The electronic device according to claim 10, wherein the one or more processors are further caused to perform at least one of following:
decrypting the target processing result fed back by the target processing device by using the key data exchanged with the target processing device, and displaying and outputting the decrypted target processing result on a window interface of a first application or a current display interface of the client device;
when the target processing task is not a single task, respectively displaying and outputting multiple corresponding processing results to a same input area or different input areas of the client device, wherein the different input areas belong to or do not belong to a same application; or
decrypting the target processing result fed back by the target processing device using the key data exchanged with the target processing device, and sending the decrypted target processing result to an associated device of the client device, so that the decrypted target processing result is displayed and output by the associated device, wherein the associated device is a device that establishes a third connection with the client device.

16. An electronic device, comprising one or more processors and a memory containing a computer program that, when being executed, causes the one or more processors to perform the method according to claim 7.

17. The electronic device according to claim 16, wherein the one or more processors are further caused to perform at least one of following:
when the task information matches a functional service and/or hardware resources configured by the first processing device, calling a target functional service or a local target model to process the target processing task;
when the task information does not match functional services configured by the first processing device, sending the target processing task to at least one fourth processing device in the device group for processing;
when the task information does not match the hardware resources configured by the first processing device, sending a portion of the target processing task to at least one fifth processing device in the device group, so as to cooperate with the fifth processing device to perform the target processing task; or
when the target processing task is not a single task, sending at least some of multiple processing tasks to at least one sixth processing device in the device group, so as to cooperate with the sixth processing device to execute the multiple processing tasks.

18. The electronic device according to claim 16, wherein the one or more processors are further caused to perform at least one of following:
processing obtained processing results fed back by the fourth processing device and/or the fifth processing device into the target processing result, encrypting the target processing result and sending the encrypted target processing result to the client device through the second connection; or
sending device network information of the client device to a sixth processing device, so that the sixth processing device establishes a third connection with the client device, and the sixth processing device sends the target processing result obtained by processing the corresponding processing task to the client device through the third connection.

19. A non-transitory computer readable storage medium containing a computer program that, when being executed, causes at least one processor to perform the method according to claim 1.

20. A non-transitory computer readable storage medium containing a computer program that, when being executed, causes at least one processor to perform the method according to claim 7.
